(19) United States
(12) Patent Application Publication
(10) Pub. No.: US 2006/0024524 A1
(43) Pub. Date: Feb. 2, 2006

(54) Electroluminescent device, and method for producing the same

(76) Inventor: Tomoyuki Tachikawa, Tokyo (JP)

Correspondence Address: SEYFARTH SHAW LLP, 55 EAST MONROE STREET, SUITE 4200, CHICAGO, IL, 60603-5803, US

(21) Appl. No.: 11/186,512

(22) Filed: Jul. 21, 2005

(30) Foreign Application Priority Data
Jul. 28, 2004 (JP) 2004-219617

(51) Int. Cl. B32B 19/00

(52) U.S. Cl. 428/690; 216/24

(57) ABSTRACT

The present invention provides a device capable of obtaining stable luminescence with a long life by preventing the insulating layer loss by in an etching process and thus preventing the short circuit defect in the device as well as providing the advantages of the photolithographic process, and a method for producing the same. There are provided an electroluminescent device comprising a first electrode layer, an insulating layer, an electroluminescent layer, and a second electrode layer on a substrate, wherein at least one layer of the electroluminescent layer is formed into a predetermined pattern by photolithography, and the insulating layer comprises an inorganic material having 2.5 or more etching selectivity to an organic compound in the dry etching process, or an organopolysiloxane comprising a hydrolysis-condensation product or a hydrolysis-cocondensation product of one or more kinds of specific silicon compounds, and a method for manufacturing the same.

The disclosure of Japanese Patent Application No. 2004-219617 filed Jul. 28, 2004 including specification, drawings and claims is incorporated herein by reference in its entirety.

### BACKGROUND OF THE INVENTION

1. Field of the Invention

The present invention relates to an electroluminescent (hereinafter, “electroluminescent” may be abbreviated as “EL”) device having an electroluminescent layer formed by photolithography, and a method for producing the same.

2. Description of the Related Art

In an EL device, holes and electrons, which are injected from electrodes facing each other, are combined to each other in a light-emitting layer, whereby the resulting energy excites a fluorescent material in the light-emitting layer and luminescence of a color in accordance with the fluorescent material is produced, so that EL devices attract the attention as a self-luminous sheet-shaped display element. Among EL devices, an organic film EL display, which employs an organic material as a light-emitting material, exhibits relatively high luminescence efficiency such that luminescence of high intensity can be realized when voltage a little less than 10 V is applied, and emitting light with a simple device structure is possible. Accordingly, it is expected that the organic film EL display can be applied to a low-cost indication display having a simple structure, such as an advertisement device which indicates specific patterns by emitting light.

In the production of a display using such an EL device, in general, an electrode layer and an organic EL layer are patterned. As a method for patterning the EL device, a method of vapor-depositing a light-emitting material via a shadow mask, a method of coating selectively by inkjet, a method of destroying a specific light-emitting colorants by ultraviolet ray irradiation, a screen printing method, or the like can be presented. However, according to the aforementioned conventional methods, it is not possible to provide an EL element which satisfies all the requirements such as high luminescence efficiency, high “yield” of light eventually obtained, simple and easy production process and highly minute and precise pattern formation.

As a solution for solving the problems described above, a method for producing an EL device has been proposed, in which a light-emitting layer is formed by patterning by photolithography. This method needs no vacuum facilities and the like equipped with highly precise alignment mechanism so that it makes production of EL devices relatively easy in low cost, as compared with the conventional patterning method by vapor-depositing. On the other hand, this method is preferable because auxiliary structures for patterning or pre-treatments of a substrate are not necessary, as compared with the patterning method using inkjet. To form highly precise patterns, the method for producing an EL device by photolithography is more advantageous and preferable than the patterning method using inkjet, considering a discharge precision of an inkjet head.

As a method for forming a plurality of light-emitting portions by such photolithography, for example, a method shown in FIG. 4 has been proposed (Japanese Patent Application Laid-Open (JP-A) No. 2002-170673).

First, as shown in FIG. 4A, a light-emitting layer 4 is coated onto a substrate 1 with an electrode provided, and as shown in FIG. 4B, a photoresist layer 6 is laminated thereon. Then, as shown in FIG. 4C, only a portion for forming a first light-emitting portion is masked by a photomask 7, and the remaining portions are exposed to an ultraviolet ray 8. The product is developed by a photoresist developer and washed, whereby the photoresist layer 6 of the exposed portion is removed as shown in FIG. 4D. Furthermore, portions of the light-emitting layer, which is bared as a result of removal of the photoresist layer at the exposed portion, are removed by etching, and then FIG. 4E is obtained.

By repeating the above-mentioned process by three times, three kinds of light-emitting potions can be patterned. Finally, by peeling treatment using a photoresist peeling solution, as shown in FIG. 4N, three kinds of the light-emitting portions 6, 9, 10 are bared. Thereafter, further processes including a process of forming a second electrode layer on each light-emitting portion are carried out, whereby an EL device which emits luminescence in the direction toward the bottom of the page in the figure is produced.

In patterning by photolithography as mentioned above, dry etching is used frequently as the etching method because the dry etching can remove the organic substance efficiently and etch without residues. However, although the etching speed differs slightly depending on the kind of the organic material, the dry etching etches most of the organic material consequently without selectivity.

In general, an organic EL device is provided with an insulating layer for preventing the short circuit between an anode and a cathode or between the electrode and a wiring. Since the insulating layer is produced with an organic material such as a thermosetting resin and an ultraviolet curing resin, the insulating layer is also etched at the time of dry etching so that a problem of causing the short circuit between an anode and a cathode or between the electrode and a wiring due to the loss of the insulation property has caused.

### SUMMARY OF THE INVENTION

The present invention has been achieved in view of the above-mentioned problems, and the main object thereof is to provide a device capable of obtaining stable luminescence with a long life by preventing the insulating layer loss by in an etching process and thus preventing the short circuit defect in the device as well as providing the advantages of the photolithographic process, and a method for producing the same.

The present invention provides an electroluminescent device comprising a first electrode layer, an insulating layer, an electroluminescent layer, and a second electrode layer on a substrate, wherein at least one layer of the electroluminescent layer is formed into a predetermined pattern by photolithography comprising a dry etching process with use of a predetermined gas, and the insulating layer comprises an inorganic material having 2.5 or more etching selectivity to an organic compound in the dry etching process with use of the predetermined gas.

Moreover, the present invention provides an electroluminescent device comprising a first electrode layer, an insulating layer, an electroluminescent layer, and a second electrode layer on a substrate, wherein at least one layer of the electroluminescent layer is formed into a predetermined pattern by photolithography, and the insulating layer comprises an organopolysiloxane comprising a hydrolysis-condensation product or a hydrolysis-cocondensation product of one or more kinds of silicon compounds represented by YₙSiX₍₄₋ₙ₎, wherein ‘Y’ denotes an alkyl group, a fluoroalkyl group, a vinyl group, an amino group, a phenyl group or an epoxy group; ‘X’ denotes an alkoxyl group or a halogen atom, and ‘n’ denotes an integer of from 0 to 3.

Since the electroluminescent device of the present invention comprises the insulating layer comprising an inorganic material having 2.5 or more etching selectivity to an organic compound in the dry etching process, or comprising an organopolysiloxane comprising a hydrolysis-condensation product or a hydrolysis-cocondensation product of one or more kinds of silicon compounds as mentioned above, even when dry etching is used at the time of patterning by photolithography, erosion to the insulating layer can be prevented so that the advantages of the photolithographic process process can be provided without generating the short circuit between the electrodes or between the electrode and the wiring. Here, erosion to the insulating layer refers to regression of thickness and/or area of the insulating layer. That is, according to the present invention, there can be obtained a device with a highly minute and precise pattern formed relatively easily and inexpensively, capable of obtaining stable luminescence with a long life while preventing the defect of the short circuit of the device.

It is preferable to use a gas comprising oxygen alone or a gas containing oxygen for the dry etching process in the choice of the inorganic material. Since the oxygen is a safe and stably accessible material without toxicity, and furthermore it is effective as an etching gas for the high reactivity, it can be used preferably in the dry etching process.

It is preferable that the above-mentioned inorganic material comprises an oxide of silicon and/or a nitride of silicon. They are a stably accessible insulating material without toxicity.

It is preferable that the insulating layer of the device of the present invention is disposed between the first electrode layer and the second electrode layer in terms of the short circuit prevention.

Moreover, it is preferable that the insulating layer of the device of the present invention is disposed between a substrate wiring and the first electrode layer and/or between a substrate wiring and the second electrode layer in terms of the short circuit prevention.

Furthermore, the present invention provides a method for producing an electroluminescent device comprising steps of:
forming an insulating layer with use of a material containing an inorganic material having 2.5 or more etching selectivity to an organic compound in a dry etching process with use of a predetermined gas; and,
forming at least one electroluminescent layer composing an electroluminescent device into a predetermined pattern by photolithography comprising the dry etching process with use of the predetermined gas.

Moreover, the present invention provides a method for producing an electroluminescent device comprising steps of:
forming an insulating layer with use of a material containing an organopolysiloxane comprising a hydrolysis-condensation product or a hydrolysis-cocondensation product of one or more kinds of silicon compounds represented by YₙSiX₍₄₋ₙ₎, wherein ‘Y’ denotes an alkyl group, a fluoroalkyl group, a vinyl group, an amino group, a phenyl group or an epoxy group; ‘X’ denotes an alkoxyl group or a halogen atom, and ‘n’ denotes an integer of from 0 to 3; and,
forming at least one electroluminescent layer composing an electroluminescent device into a predetermined pattern by photolithography.

Since the method for producing an electroluminescent device of the present invention comprises a step of forming an insulating layer comprising an inorganic material having 2.5 or more etching selectivity to an organic compound in the dry etching process, or comprising an organopolysiloxane comprising a hydrolysis-condensation product or a hydrolysis-cocondensation product of one or more kinds of silicon compounds as mentioned above, even when dry etching is used in the step of patterning by photolithography, erosion to the insulating layer can be prevented so that the advantages of the photolithographic process process can be provided without generating the short circuit between the electrodes or between the electrode and the wiring.

It is preferable that the above-mentioned step of forming the predetermined pattern by photolithography is carried out by coating the electroluminescent layer to be formed into the predetermined pattern with a photoresist, exposing and developing the same to form the photoresist into the predetermined pattern, and thereafter subjecting the electroluminescent layer to dry etching process with use of a predetermined gas to remove the same from a portion where the photoresist is removed in terms of obtaining a highly minute and precise pattern.

Moreover, it is preferable that the dry etching process in the production method of the present invention is a reactive ion etching process because it is an effective etching process.

Furthermore, it is preferable to use the predetermined gas comprising oxygen alone or a gas containing oxygen in the dry etching process in the production method according to the present invention. Oxygen is a safe and stably accessible material without toxicity, and furthermore, it can etch the electroluminescent layer effectively by the oxidation reaction without influencing the substrate such as a glass and an ITO.

Moreover, in the production method according to the present invention, it is preferable that the inorganic material comprises an oxide of silicon and/or a nitride of silicon because they are a stably accessible insulating material without toxicity.

In the production method according to the present invention, it is preferable that the insulating layer is disposed between the first electrode layer and the second electrode layer in terms of the short circuit prevention.

Moreover, in the production method according to the present invention, it is preferable that the insulating layer is disposed between a substrate wiring and the first electrode layer and/or between a substrate wiring and the second electrode layer in terms of the short circuit prevention.

According to the electroluminescent device of the present invention and the method for producing the same, even when dry etching is used at the time of patterning by photolithography, erosion to the insulating layer can be prevented so that the advantages of the photolithographic process process can be provided without generating the short circuit between the electrodes or between the electrode and the wiring. That is, according to the present invention, a device with a highly minute and precise pattern formed relatively easily and inexpensively, capable of obtaining stable luminescence with a long life while preventing the defect of the short circuit of the device can be obtained.

### BRIEF DESCRIPTION OF THE DRAWINGS

FIGS. 1A to 1C are cross-sectional views showing an example of an EL device according to the present invention.

FIGS. 2A to 2R are cross-sectional views showing an example of process of patterning by photolithography.

FIG. 3A is a cross-sectional view showing an example of an EL device using photolithography, FIGS. 3B and 3C are cross-sectional views showing examples of the conventional EL devices.

FIGS. 4A to 4N are cross-sectional views showing an example of process of patterning by photolithography.

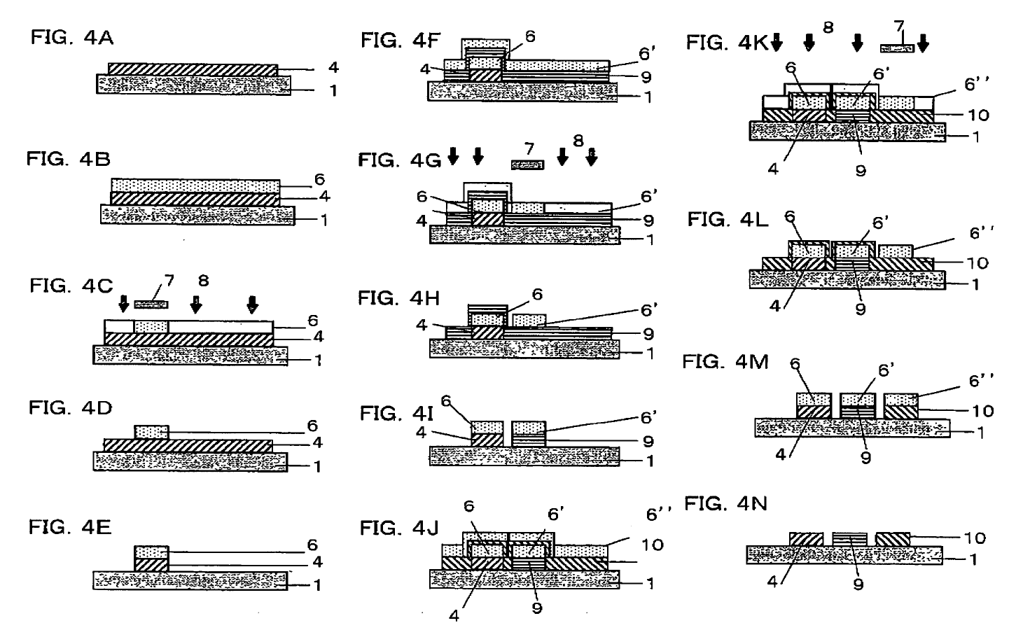

FIGS. 5A to 5C are cross-sectional views showing an example of the conventional EL device.

### DETAILED DESCRIPTION OF THE INVENTION

1. Electroluminescent Device

An electroluminescent device according to the present invention comprises a first electrode layer, an insulating layer, an electroluminescent layer, and a second electrode layer on a substrate, wherein at least one layer of the electroluminescent layer is formed into a predetermined pattern by photolithography comprising a dry etching process with use of a predetermined gas, and the insulating layer comprises an inorganic material having 2.5 or more etching selectivity to an organic compound in the dry etching process with use of the predetermined gas.

Moreover, an electroluminescent device according to the present invention comprises a first electrode layer, an insulating layer, an electroluminescent layer, and a second electrode layer on a substrate, wherein at least one layer of the electroluminescent layer is formed into a predetermined pattern by photolithography, and the insulating layer comprises an organopolysiloxane comprising a hydrolysis-condensation product or a hydrolysis-cocondensation product of one or more kinds of silicon compounds represented by YₙSiX₍₄₋ₙ₎, wherein ‘Y’ denotes an alkyl group, a fluoroalkyl group, a vinyl group, an amino group, a phenyl group or an epoxy group; ‘X’ denotes an alkoxyl group or a halogen atom, and ‘n’ denotes an integer of from 0 to 3.

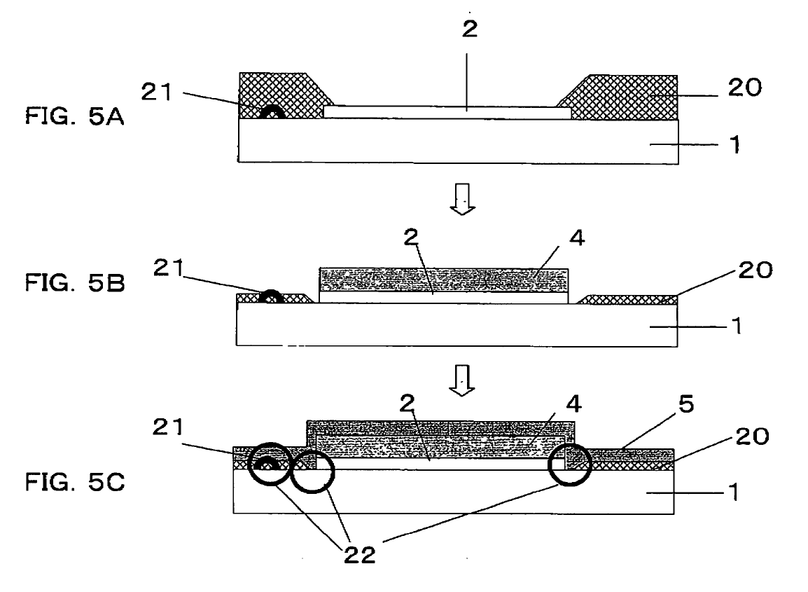

As shown in FIG. 5, since an insulating layer 20 has conventionally been produced with an organic material such as a thermosetting resin and an ultraviolet curing resin, if an EL layer 4 is patterned by photolithography, the insulating layer was also eroded at the time of dry etching so that a wiring 21 was exposed or a gap was formed between a first electrode 2 and the insulating layer 20 (FIG. 5B). When a second electrode was laminated in such a state with the insulating layer 20 etched, the second electrode came in contact with the side surface of the first electrode so as to form a conduction path and cause the short circuit 22, or the second electrode came in contact with the exposed wiring 21 so as to form a conduction path and cause the short circuit 22, and thus it was problematic (FIG. 5C).

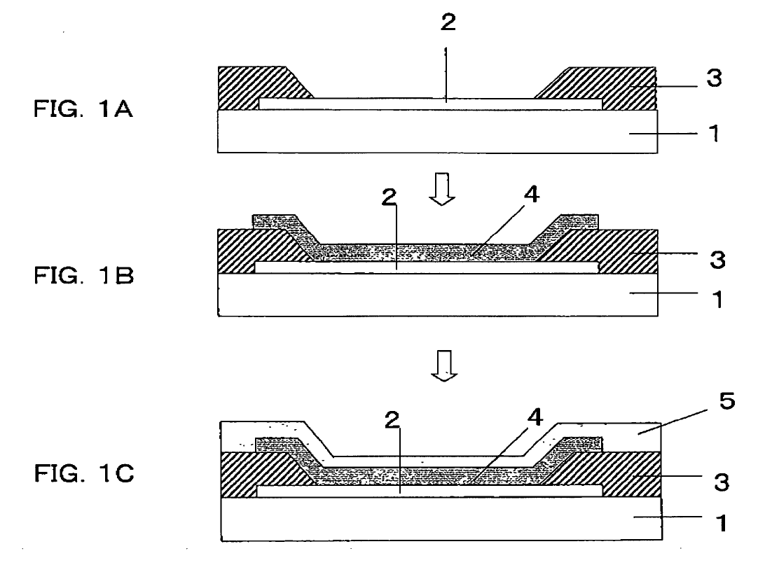

As shown in FIG. 1, since the EL device according to the present invention comprises an insulating layer comprising an inorganic material having 2.5 or more etching selectivity to an organic compound in the dry etching process with use of the predetermined gas, or an organopolysiloxane comprising a hydrolysis-condensation product or a hydrolysis-cocondensation product of one or more kinds of silicon compounds as mentioned above (FIG. 1A), even when dry etching is used at the time of patterning by photolithography, erosion to the insulating layer can be prevented (FIG. 1B). Therefore, according to the EL device of the present invention, since the second electrode does not come in contact with the first electrode 2 or the wiring (not shown) even when the second electrode is laminated (FIG. 1C), the advantages of the photolithographic process can be provided without generating the short circuit between the first electrode and the second electrode or between the electrodes and the wiring. That is, according to the present invention, a device with a highly minute and precise pattern formed relatively easily and inexpensively, capable of obtaining stable luminescence with a long life with the short circuit defect of the device prevented can be obtained.

FIG. 1C is a schematic cross-sectional view showing an example of an EL device according to the present invention. In FIG. 1C, the EL device comprises a substrate 1, a first electrode layer 2 formed on the substrate 1, an insulating layer 3 formed so as to cover the edge portion on the first electrode layer 2 and the non light-emitting portion of the device, an EL layer 4 comprising at least a light-emitting layer formed on the first electrode, and a second electrode layer 5 formed on the EL layer 4, wherein at least one layer of the EL layer 4 is patterned by photolithography.

Hereinafter, the constituent elements of the EL device of the present invention will be explained. The patterning operation by photolithography will be explained in detailed in the method for producing an El device according to the present invention to be described later.

(Substrate)

A substrate provides the supporting medium for the EL device, which may be made of either a flexible material or a hard material. As the substrate for the EL device used in the present invention, substrates used for the conventional EL devices, of glass, a plastic sheet, or the like can be used, and it is not particularly limited. The thickness of the substrates is in general about 0.1 to 2.0 mm.

(First and Second Electrodes)

In the present invention, a first electrode layer is formed on the substrate, and furthermore a second electrode layer is formed on the above-mentioned EL layer. These electrodes comprise an anode and a cathode. Depending on the direction of bringing out the luminescence emitted from the EL layer 4, to which electrode the transparency is required differs. In the case of bringing out the luminescence from the substrate 1 side, the first electrode needs to be made of a transparent or semitransparent material, and in the case of bringing out the luminescence from the second electrode side, the second electrode needs to be made of a transparent or semitransparent material.

An electrode is preferably made of a conductive material having a resistance as small as possible. In general, a metal material is used, but it may be an organic compound or an inorganic compound. Moreover, it may be formed as a mixture of a plurality of materials.

An anode is preferably made of a conductive material having a large work function, so that positive holes can easily be injected. As a preferable anode material, for example, an indium oxide, gold, or the like can be presented.

A cathode is preferably made of a conductive material having a small work function, so that electrons can easily be injected. As a preferable cathode material, for example, a magnesium alloy (Mg—Ag, or the like), an aluminum alloy (Al—Li, Al—Ca, Al—Mg, or the like), a metallic calcium, and a metal having a small work function can be presented. The thickness of these electrode layers is each in general about 20 to 1,000.

(Insulating Layer)

When an insulating layer is required in an EL device, the insulating layer is provided in general between the first electrode layer and the second electrode layer in terms of the short circuit prevention. Moreover, when a wiring is provided on the substrate, the insulating layer is provided also between the wiring on the substrate and the first electrode layer and/or between the wiring on the substrate and the second electrode layer in terms of the short circuit prevention. Moreover, “between” the first electrode layer and the second electrode layer and “between” the wiring on the substrate and the electrode layer include not only the case of disposing spatially therebetween but also the case of disposing between the conduction paths thereof.

The insulating layer is provided in order to prevent the short circuit in an unnecessary portion of the light emission, for example, it is preliminarily provided so as to cover the edge portion of the first electrode formed in a pattern on the substrate and the non light-emitting portions of the device and make an opening at the light-emitting portion, and thus can be disposed between the first electrode and the second electrode, and, between the wiring on the substrate and the first electrode and/or between the wiring on the substrate and the second electrode. According to the configuration, the detects by the short circuit of the device can be reduced so that a device capable of stably emitting a luminescence with a long life can be obtained.

When the EL layer is patterned by dry etching in the photolithographic process, it is preferable that the insulating layer has the dry etching resistance. When the principal component of the EL layer to be patterned is an organic material, the reactive ion etching to be used preferably as a dry etching process, can be carried out by for example generating a plasma using a reactive gas such as oxygen alone or a gas containing oxygen, and removing the organic material as a gas generated by the chemical reaction with the reactive gas. Therefore, an insulating layer not to be reacted with the predetermined gas used for the dry etching process can be used preferably.

In the present invention, the insulating layer comprises an inorganic material having 2.5 or more etching selectivity to an organic compound in the dry etching process with use of the predetermined gas (first embodiment of the insulating layer), or the insulating layer comprises an organopolysiloxane comprising a hydrolysis-condensation product or a hydrolysis-cocondensation product of one or more kinds of silicon compounds represented by YₙSiX₍₄₋ₙ₎, wherein ‘Y’ denotes an alkyl group, a fluoroalkyl group, a vinyl group, an amino group, a phenyl group or an epoxy group; ‘X’ denotes an alkoxyl group or a halogen atom, and ‘n’ denotes an integer of from 0 to 3 (second embodiment of the insulating layer). Therefore, even when dry etching is used at the time of patterning by photolithography, erosion to the insulating layer can be prevented.

Moreover, in general, in the substrate washing process, a plasma process using an argon or oxygen is used as the dry washing process. In the case of washing, even though the damage to the substrate is not as serious as it is in the case of the dry etching for patterning, the film surface may get rough. When an inorganic insulating layer according to the present invention is used, the effect of preventing roughening of the film surface in the general dry washing process can also be provided.

i) First Embodiment of the Insulating Layer

An inorganic material used for the first embodiment of the insulating layer is an inorganic material having the insulating property, and 2.5 or more etching selectivity to an organic compound in the dry etching process with use of the predetermined gas.

Here, the selectivity in the dry etching process refers to the ratio of the etching rate of the substance to be etched and the etching rate of the substance not to be etched (etching rate of the substance to be etched/etching rate of the substance not to be etched). In the present invention, it refers to the ratio of the etching rate of the organic compound and the etching rate of the inorganic material used for the insulating layer (etching rate of the organic compound/etching rate of the inorganic material used for the insulating layer). The organic compound here is the main component of the materials for forming at least one layer of the electroluminescent layers to be patterned by photolithography including the dry etching process. As the standard substance, a light-emitting material, such as a polyvinyl carbazol, a polyparaphenylene vinylene, polythiophene, and a polyfluorene can be used.

Since an inorganic material having 2.5 or more etching selectivity to an organic compound in the dry etching process has a high selectivity to the EL layer in the etching conditions for etching the EL layers made from an organic compound as the major component, it cannot be eroded.

The inorganic material in the present invention has 2.5 or more selectivity to the organic compound in the dry etching process with use of the predetermined gas. It is preferably 3 or more, more preferably 4 or more, and still more preferably 5 or more.

The inorganic material in the present invention denotes a material comprising mainly an inorganic compound, and thus an organic-inorganic composite is also included herein.

Moreover, in terms of the insulating property, among the inorganic materials, those having 10¹⁰ or more specific resistance (Ω cm) should be selected. Furthermore, it is preferable to select those having 10¹² or more specific resistance (Ω cm). Here, the specific resistance (Ω cm) can be calculated by (electric resistivity×cross-sectional area/length).

Moreover, in the above-mentioned dry etching process, it is preferable to use oxygen alone or a gas containing oxygen. Since the oxygen is a safe and stably accessible material without toxicity, and furthermore it is effective as an etching gas for the high reactivity, it can be used preferably in the dry etching process to be used for photolithography in the present invention.

As the inorganic materials having the insulating property and 2.5 or more selectivity to the organic compound in the dry etching process, for example, an oxide of silicon (for example, SiOx (x is 1 or more and 2 or less)), a nitride of silicon (for example, SiNx (x is 1/2 or more and 4/3 or less), SiON, SiAlON, SiOF, an aluminum oxide, a tantalum oxide, a titanium oxide, a tin oxide, a vanadium oxide, a barium strontium titanate, a barium zirconate titanate, a lead zirconate titanate, a lead lanthanum titanate, a strontium titanate, a barium titanate, a barium magnesium fluoride, a bismuth titanate, a strontium bismuth titanate, a strontium bismuth tantalate, a bismuth tantalate niobate, yttrium trioxide, or the like can be presented.

In particular, it is preferable that the inorganic material comprises an oxide of silicon and/or a nitride of silicon. The oxide of silicon and/or the nitride of silicon is a safe and stably accessible insulating material without toxicity. Moreover, they can easily form a film by sputtering, deposition process, or the like. Among the oxide of silicon and/or the nitride of silicon, SiOx (x is 1 or more and 2 or less), and SiNx (x is 1/2 or more and 4/3 or less) can be used preferably. Especially SiOx (x is 2), SiNx (x is 4/3) can be used particularly preferably in the present invention.

The first embodiment of the insulating layer may contain components other than the inorganic material having 2.5 or more selectivity to the organic compound in the dry etching process within the range not to deteriorate the effects of the present invention. Also in this case, the content of the organic material having 2.5 or more selectivity to the organic compound in the dry etching process is preferably 50% by weight or more in the insulating layer, more preferably 70% by weight or more, and particularly preferably by 90% by weight or more in terms of the dry etching resistance. It is particularly preferable that the insulating layer is made of an inorganic material having 2.5 or more selectivity to the organic compound in the dry etching process in terms of the dry etching resistance and the insulating property.

ii) Second Embodiment of the Insulating Layer

An organopolysiloxane comprising a hydrolysis-condensation product or a hydrolysis-cocondensation product of one or more kinds of silicon compounds represented by YₙSiX₍₄₋ₙ₎, wherein ‘Y’ denotes an alkyl group, a fluoroalkyl group, a vinyl group, an amino group, a phenyl group or an epoxy group; ‘X’ denotes an alkoxyl group or a halogen atom, and ‘n’ denotes an integer of from 0 to 3 used in the second embodiment of the insulating layer is preferable since a firm and even layer having the dry etching resistance can be formed by the polymerization of the molecules by the hydrolysis and the polycondensation of the halogen and/or the alkoxyl group by the sol-gel reaction or the like, and the coating operation can be enabled easily by a wet-type method, or the like.

As the silicon compound represented by YnSiX (4−n) as mentioned above, specifically, methyl trichlorosilane, methyl tribromosilane, methyl trimethoxy silane, methyl triethoxy silane, methyltriisopropoxysilane, methyltri-t-butoxysilane; ethyl trichlorosilane, ethyl tribromosilane, ethyl trimethoxy silane, ethyl triethoxy silane, ethyl triisopropoxysilane, ethyl tri-t-butoxy silane; n-propyl trichlorosilane, n-propyl tribromosilane, n-propyl trimethoxy silane, n-propyl triethoxy silane, n-propyl triisopropoxy silane, n-propyl tri-t-butoxy silane; n-hexyl trichlorosilane, n-hexyl tribromosilane, n-hexyl trimethoxy silane, n-hexyl triethoxy silane, n-hexyl triisopropoxy silane, n-hexyl tri-t-butoxy silane; n-decyl trichlorosilane, n-decyl tribromosilane, n-decyl trimethoxy silane, n-decyl triethoxy silane, n-decyl triisopropoxy silane, n-decyl tri-t-butoxy silane; n-octadecyl trichlorosilane, n-octadecyl tribromosilane, n-orthadecyl trimethoxy silane, n-octadecyl triethoxy silane, n-octadecyl triisopropoxy silane, n-octadecyl tri-t-butoxy silane; phenyl trichlorosilane, phenyl tribromosilane, phenyl trimethoxy silane, phenyl triethoxy silane, phenyl triisopropoxysilane, phenyltri-t-butoxysilane; tetrachlorosilane, tetrabromosilane, tetramethoxy silane, tetraethoxy silane, tetrabutoxy silane, dimethoxy diethoxy silane; dimethyl dichloro silane, dimethyl dibromosilane, dimethyl dimethoxy silane, dimethyl diethoxy silane; diphenyl dichloro silane, diphenyl dibromosilane, diphenyl dimethoxy silane, diphenyl diethoxy silane; phenyl methyl dichlorosilane, phenyl methyl dibromosilane, phenyl methyl dimethoxy silane, phenyl methyl diethoxy silane; trichlorohydrosilane, tribromohydrosilane, trimethoxy hydrosilane, triethoxy hydrosilane, triisopropoxy hydrosilane, tri-t-butoxy hydrosilane; vinyl trichlorosilane, vinyl tribromosilane, vinyl trimethoxy silane, vinyl triethoxy silane, vinyl triisopropoxy silane, vinyl tri-t-butoxy silane; trifluoro propyl trichlorosilane, trifluoropropyl tribromosilane, trifluoropropyl trimethoxy silane, trifluoropropyl triethoxy silane, trifluoropropyl triisopropoxy silane, trifluoropropyl tri-t-butoxy silane; γ-glycidoxypropyl methyl dimethoxy silane, γ-glycidoxypropyl methyl diethoxy silane, γ-glycidoxypropyl trimethoxy silane, γ-glycidoxypropyl triethoxy silane, γ-glycidoxypropyl triisopropoxy silane, γ-glycidoxypropyl tri-t-butoxy silane; γ-methacryloxypropyl methyl dimethoxy silane, γ-methacryloxypropyl methyl diethoxy silane, γ-methacryloxypropyl trimethoxy silane, γ-methacryloxypropyl triethoxy silane, γ-methacryloxypropyl triisopropoxy silane, γ-methacryloxypropyl tri-t-butoxy silane; γ-aminopropyl methyl dimethoxy silane, γ-aminopropyl methyl diethoxy silane, γ-aminopropyl trimethoxy silane, γ-aminopropyl triethoxysilane, γ-aminopropyl triisopropoxy silane, γ-aminopropyl tri-t-butoxy silane; γ-mercaptopropyl methyl dimethoxy silane, γ-mercaptopropyl methyl diethoxy silane, γ-mercaptopropyl trimethoxy silane, γ-mercaptopropyl triethoxy silane, γ-mercaptopropyl triisopropoxy silane, γ-mercaptopropyl tri-t-butoxy silane; β-(3,4-epoxycyclohexyl) ethyl trimethoxy silane, β-(3,4-epoxycyclohexyl) ethyl triethoxy silane; fluoroalkylsilanes known in general as the fluorinated silane coupling agents shown below as examples; hydrolysis-condensation products or hydrolysis-cocondensation products thereof; and mixtures thereof can be presented.

CF₃(CF₂)₃CH₂CH₂Si(OCH₃)₃, CF₃(CF₂)₅CH₂CH₂Si(OCH₃)₃, CF₃(CF₂)₇CH₂CH₂Si(OCH₃)₃, CF₃(CF₂)₉CH₂CH₂Si(OCH₃)₃, (CF₃)₂CF(CF₂)₄CH₂CH₂Si(OCH₃)₃, (CF₃)₂CF(CF₂)₆CH₂CH₂Si(OCH₃)₃, (CF₃)₂CF(CF₂)₈CH₂CH₂Si(OCH₃)₃, CF₃(C₆H₄)C₂H₄Si(OCH₃)₃, CF₃(CF₂)₃(C₆H₄)C₂H₄Si(OCH₃)₃, CF₃(CF₂)₅(C₆H₄)C₂H₄Si(OCH₃)₃, CF₃(CF₂)₇(C₆H₄)C₂H₄Si(OCH₃)₃, CF₃(CF₂)₃CH₂CH₂SiCH₃(OCH₃)₂, CF₃(CF₂)₅CH₂CH₂SiCH₃(OCH₃)₂, CF₃(CF₂)₇CH₂CH₂SiCH₃(OCH₃)₂, CF₃(CF₂)₉CH₂CH₂SiCH₃(OCH₃)₂, (CF₃)₂CF(CF₂)₄CH₂CH₂SiCH₃(OCH₃)₂, (CF₃)₂CF(CF₂)₆CH₂CH₂SiCH₃(OCH₃)₂, (CF₃)₂CF(CF₂)₈CH₂CH₂SiCH₃(OCH₃)₂, CF₃(C₆H₄)C₂H₄SiCH₃(OCH₃)₂, CF₃(CF₂)₃(C₆H₄)C₂H₄SiCH₃(OCH₃)₂, CF₃(CF₂)₅(C₆H₄)C₂H₄SiCH₃(OCH₃)₂, CF₃(CF₂)₇(C₆H₄)C₂H₄SiCH₃(OCH₃)₂, CF₃(CF₂)₃CH₂CH₂Si(OCH₂CH₃)₃, CF₃(CF₂)₅CH₂CH₂Si(OCH₂CH₃)₃, CF₃(CF₂)₇CH₂CH₂Si(OCH₂CH₃)₃, CF₃(CF₂)₉CH₂CH₂Si(OCH₂CH₃)₃, CF₃(CF₂)₇SO₂N(C₂H₅)C₂H₄CH₂Si(OCH₃)₃.

Among the above-mentioned organopolysiloxanes, it is preferable to include a large number of functional groups capable of providing a cross-linking point such as an alkoxyl group and a halogen in terms of forming a firm film by cross-linking for the purpose of improving the dry etching resistance. Therefore, among the silicon compounds represented by YₙSiX₍₄₋ₙ₎, wherein “Y” denotes an alkyl croup, a fluoroalkyl group, a vinyl group, an amino group, a phenyl group or an epoxy group; ‘X’ denotes an alkoxyl group or a halogen atom, and ‘n’ denotes an integer of from 0 to 3, n is preferably smaller, and in particular, n is preferably 0.

Moreover, the second embodiment of the insulating layer may contain components other than the above-mentioned organopolysiloxane within the range not to deteriorate the effects of the present invention. Also in this case, the content of the above-mentioned organopolysiloxane is preferably 50% by weight or more in the insulating layer, more preferably 70% by weight or more, and particularly preferably by 90% by weight or more in terms of the dry etching resistance. It is particularly preferable that the insulating layer is made of the above-mentioned organopolysiloxane in terms of the dry etching resistance and the insulating property.

Moreover, also in the second embodiment, the insulating layer having 10¹⁰ or more specific resistance (Ω cm) should be selected in the present invention. Furthermore, it is preferable to select those of 10¹² or more.

Moreover, the thickness of the insulating layer in the present invention is preferably 0.1 μm to 5 μm in terms of the insulating property, and it is further preferably 0.5 μm to 1.5 μm. When it is too thick, the second electrode may be broken or the patterning failure of the insulating layer may be generated, and when it is too thin, the short circuit may be generated.

(EL Layer)

At least one layer of the EL layer 4 is formed into a predetermined pattern by photolithography. The EL layer should include at least a light-emitting layer. Additionally, a buffer layer, a positive hole transporting layer, a positive hole injection layer, an electron transporting layer, an electron injection layer, or the like may be combined.

Moreover, the above-mentioned EL layer to be patterned may be any of the above-mentioned layers comprising the EL layer. In the present invention, it is preferably a light-emitting layer or a buffer layer. In particular, it is preferable that a light-emitting layer is the EL layer formed into a predetermined pattern in terms of producing the area color or full color display device. Furthermore, in terms of the carrier injection balance of the EL device, it is further preferable that the light-emitting layer and the buffer layer are patterned as the EL layer.

Moreover, in the case of a full color EL device, the EL layer may be an EL layer with the light-emitting layer provided as three kinds of light-emitting layers and patterned by photolithography by three times.

[Light-Emitting Layer]

The light-emitting layer to be formed on the first electrode layer is preferably an organic light-emitting layer in the present invention. In general, it is mainly made of an organic substance for emitting fluorescence or phosphorescence (a low molecular compound and a polymer compound), and an assist dopant therefor. When the light-emitting layer is formed into a predetermined pattern by photolithography, it is preferable that the material which constitutes the light-emitting layer is not soluble to any of the below described photoresist solvent, the photoresist developer and the photoresist peeling solution to be used in the photolithographic process.

As the material for forming the light-emitting layer to be used in the present invention, for example, the following can be presented.

<Pigment Based Material>

As the pigment based material, for example, a cyclopentamine derivative, a tetraphenyl butadiene derivative, a triphenyl amine derivative, an oxadiazol derivative, a pyrazoloquinoline derivative, a distylylbenzene derivative, a distylylarylene derivative, a pyrrole derivative, a thiophene ring compound, a pyridine ring compound, a perinone derivative, a perylene derivative, an oligothiophene derivative, a trifumanylamine derivative, an oxadiazol dimer, a pyrazoline dimer, or the like can be presented.

<Metal Complex Based Material>

As the metal complex based material, a metal complex which has Al, Zn, Be or rare metals such as Tb, Eu, Dy as a core metal, and has oxadiazole, thiadiazole, phenylpyridine, phenylbenzoimidazole or a quinoline structure as a ligand. Specific examples of such metal complex include an aluminum-quinolinol complex, a benzoquinolinol-beryllium complex, a benzooxazole-zinc complex, a benzothiazole-zinc complex, an azomethyl-zinc complex, a porphyrin-zinc complex, and europium complex.

<Polymer Based Material>

As the polymer based material, a polyparaphenylene vinylene derivative, a polythiophene derivative, a polyparaphenylene derivative, a polysilane derivative, a polyacetylene derivative, a polyfluolene derivative, a polyvinyl carbazol derivative, a polymer of the above-mentioned pigment material or metal complex based light-emitting material, or the like can be presented.

Among the above-mentioned light-emitting materials, as the materials for emitting a blue luminescence, a distyrylarylene derivative, an oxadiazol derivative, and a polymer thereof, a polyvinyl carbazol derivative, a polyparaphenylene derivative, a polyfluolene derivative, or the like can be presented. In particular, the polymer materials including a polyvinyl carbazol derivative, a polyparaphenylene derivative, a polyfluolene derivative, or the like are preferable.

Moreover, as the materials for emitting a green luminescence, a quinacrydone derivative, a coumarine derivative, a polymer thereof, a polyparaphenylene vinylene derivative, a polyfluolene derivative, or the like can be presented. In particular, the polymer materials including a polyparaphenylene vinylene derivative, a polyfluolene derivative, or the like are preferable.

Moreover, as the materials for emitting a red luminescence, a coumarine derivative, a thiophene ring compound, and a polymer thereof, a polyparaphenylene vinylene derivative, a polythiophene derivative, a polyfluolene derivative, or the like can be presented. In particular, the polymer materials including a polyparaphenylene vinylene derivative, a polythiophene derivative, a polyfluolene derivative, or the like are preferable.

<Dopant Material>

A dopant can be added for the purpose of improving the luminous efficiency in the light-emitting layer, changing the luminescence wavelength, or the like. As such a dopant, for example, a perylene derivative, a coumarine derivative, a rubrene derivative, a quinacrydone derivative, a squarium derivative, a porphyrin derivative, a styryl based pigment, a tetracene derivative, a pyrazolone derivative, a decacyclene, a phenoxazone, or the like can be presented.

The thickness of such a light-emitting layer is in general each about 20 to 2,000 Å.

[Buffer Layer]

The buffer layer in the present invention is a layer containing an organic substance, in particular, an organic conductive substance, provided between an anode and a light-emitting layer or a cathode and a light-emitting layer so as to facilitate injection of the charge into the light-emitting layer. For example, the buffer layer can be made of a conductive polymer having the function of improving the positive hole injection efficiency to the light-emitting layer and making an irregular surface of the electrode or the like sufficiently flat.

When the buffer layer of the present invention is highly conductive, it is preferable that the buffer layer is patterned so that the diode property of the element is maintained and crosstalk is prevented. When the buffer layer has high resistance, or the like, it may not be patterned in some cases, and moreover, in the case of an device capable of omitting the buffer layer, the buffer layer may not be provided.

In the present invention, when both the buffer layer and the light-emitting layer are formed by patterning according to photolithography, it is preferable to select the material for forming the buffer layer insoluble to the following photoresist solvent and the solvent used for the light-emitting layer formation. And furthermore, it is preferable to select the material for forming the buffer layer insoluble to the following photoresist peeling solution.

On the other hand, when the light-emitting layer is formed by the vacuum deposition, or the like, and the layer formed by patterning according to photolithography as the EL layer is only the buffer layer, it is preferable to select the material for forming the buffer layer insoluble to the following photoresist solvent and the following photoresist peeling solution.

As the material for forming the buffer layer, specifically, polymers of a positive hole transporting substance such as a polyalkyl thiophene derivative, a polyaniline derivative and a triphenylamine; sol-gel films of an inorganic compound, polymeric films of an organic substance such as trifluoromethane, films of organic compounds containing Lewis acid, or the like can be presented, but it is not particularly limited as long as the above-mentioned conditions concerning the solubility are satisfied. The above-mentioned conditions may be satisfied as the result of reaction, polymerization, baking, or the like after the film formation. Moreover, when the light-emitting layer is formed by the vacuum film formation or the like, the buffer material, the positive hole injection material, the positive hole transporting material used generally can be used.

The thickness of the above-mentioned buffer layer is in general about 100 to 2,000 Å.

(Charge Transporting/Injection Layer)

In the EL device of the present invention, a positive hole transporting layer, a positive hole injection layer, an electron transporting layer, and an electron injection layer may be formed. These are not particularly limited as long as they are those commonly used in the conventional EL devices as for example ones disclosed in Japanese Patent Application Laid Open (JP-A) No. 11-4011.

2. Production Method for the Electroluminescent Device

The method for producing an electroluminescent device according to the present invention comprises steps of:
forming an insulating layer with use of a material containing an inorganic material having 2.5 or more etching selectivity to an organic compound in a dry etching process with use of a predetermined gas; and,
forming at least one electroluminescent layer composing an electroluminescent device into a predetermined pattern by photolithography comprising the dry etching process with use of the predetermined gas.

Moreover, the method for producing an electroluminescent device according to the present invention comprises steps of:
forming an insulating layer with use of a material containing an organopolysiloxane comprising a hydrolysis-condensation product or a hydrolysis-cocondensation product of one or more kinds of silicon compounds represented by YₙSiX₍₄₋ₙ₎, wherein ‘Y’ denotes an alkyl group, a fluoroalkyl group, a vinyl group, an amino group, a phenyl group or an epoxy group; ‘X’ denotes an alkoxyl group or a halogen atom, and ‘n’ denotes an integer of from 0 to 3; and,
forming at least one electroluminescent layer comprising an electroluminescent device into a predetermined pattern by photolithography.

Since the method for producing an electroluminescent device of the present invention comprises a step of forming an insulating layer comprising an inorganic material having 2.5 or more etching selectivity to an organic compound in the dry etching process, or comprising an organopolysiloxane comprising a hydrolysis-condensation product or a hydrolysis-cocondensation product of one or more kinds of silicon compounds as mentioned above, even when dry etching is used in the step of patterning by photolithography, erosion to the insulating layer can be prevented so that the advantages of the photolithographic process process can be provided without generating the short circuit between the electrodes or between the electrode and the wiring.

(Step for Forming the Insulating Layer)

i) First Embodiment of the Insulating Layer

The method for forming the insulating layer comprising the inorganic material having 2.5 or more etching selectivity to an organic compound in the dry etching process mentioned above is not particularly limited, and a known dry film formation method that deposits the covering material onto the surface to be covered in a gas phase state, such as a sputtering method, and a deposition method, using the above-mentioned materials can be used preferably.

ii) Second Embodiment of the Insulating Layer

The method for forming the insulating layer comprising the organopolysiloxane mentioned above is not particularly limited. Since it can be dissolved in a solvent in many cases, a known wet film formation method such as spin coating, spray coating, dip coating, roll coating and a bead coating can be used preferably. In this case, a film is formed by dissolving one or more kinds of silicon compounds represented by YₙSiX₍₄₋ₙ₎, wherein ‘Y’ denotes an alkyl group, a fluoroalkyl group, a vinyl group, an amino group, a phenyl group or an epoxy group; ‘X’ denotes an alkoxyl group or a halogen atom, and ‘n’ denotes an integer of from 0 to 3, in a suitable solvent, executing a coating operation using the wet film formation method as mentioned above, and heating the same using a heating means such as a clean oven so as to carry out the hydrolysis polycondensation reaction and drying.

The solvent to be used is one capable of dissolving the above-mentioned YnSiX(4−n). For example, it can be selected from alcohols such as ethanol and isopropanol, acetone, acetonitrile, ethylene glycol monomethyl ether, ethylene glycol dimethyl ether, dimethylformamide, dimethylsulfoxide, dioxane, ethylene glycol, hexamethylphosphoric triamide, pyridine, tetrahydrofuran, N-methylpyrrolidinone, and a solvent mixture thereof.

(Step of Forming at Least One EL Layer into a Predetermined Pattern by Photolithography)

Photolithographic process is a method of forming a desired pattern which corresponds to a light-irradiation pattern, by utilizing charges in solubility at the light-irradiated portions of a film caused by irradiation of light.

Compared with the conventional deposition method to be executed via a shadow mask, since the patterning by photolithography does not require a vacuum device, or the like, the organic EL layer can be patterned easily and inexpensively. On the other hand, compared with the patterning by the ink jet method, the patterning can be carried out highly precisely without the need of executing the pretreatment of the substrate or providing the liquid repellent projecting portions between the patterns. That is, by including step of forming at least one EL layer into a predetermined pattern by photolithography, a high quality EL device having a highly precise pattern can be obtained inexpensively.

[Photoresist]

The photoresist to be used in the present invention can either be a positive type or a negative type, and it is not particularly limited. However, The photoresist is preferably soluble to a solvent incapable of dissolving the base material and capable of being used for the coating operation, and insoluble to the solvent used for formation of the organic EL layer such as the light-emitting layer is preferable.

As the specific photoresist to be used, a novolak resin based one, a (rubber+bisazide) based one can be presented.

[Photoresist Solvent]

As the photoresist solvent used for the coating of the photoresist in the present invention, it is preferable to use a solvent which does not dissolve the EL layer forming material such as the light-emitting layer material for preventing mixture or dissolution of the above-mentioned organic EL layer such as the light-emitting layer and the photoresist material at the time of forming the photoresist, and maintaining the the original light-emitting property. In consideration of this point, as the photoresist solvent usable in the present invention, it is preferable to select a solvent having a solubility with respect to the EL layer forming material such as the light-emitting layer forming material at 25° C. and 1 atmospheric pressure of 0.001 (g/g of the solvent) or less, and it is further preferable to select one having a solubility of 0.0001 (g/g of the solvent) or less. In addition, in order to prevent mixture or dissolution with the base material, it is preferable that the condition of this solubility is used in any case described below.

For example, as the photoresist solvent usable when the buffer layer forming material is dissolved in a water based solvent and the light-emitting layer is dissolved in a non-polar organic solvent of an aromatic based one or the like, ketones such as acetone, methylethyl ketone; cellosolve acetates such as propylene glycol monoethyl ether acetate, propylene glycol monomethyl ether acetate, ethylene glycol monomethyl ether acetate, ethylene glycol monoethyl ether acetate; cellosolves such as propylene glycol monoethyl ether, propylene glycol monomethyl ether, ethylene glycol monomethyl ether, ethylene glycol monoethyl ether; alcohols such as methanol, ethanol, 1-butanol, 2-butanol, cyclohexanol; ester based solvents such as ethyl acetate, butyl acetate; cyclohexane; decalin; or the like can be presented. A solvent other than them can also be used as long as it satisfies the conditions, and a solvent mixture of two or more kinds can be used as well.

[Photoresist Developer]

The photoresist developer to be used in the present invention is not particularly limited, unless the developer dissolves the above-mentioned EL layer forming material. Specific examples of the photoresist developer include an organic alkali-based developer which is generally used. In addition thereto, an inorganic alkali-based developer; and an aqueous solution which can develop the photoresist layer can also be used. It is preferable to clean the photoresist layer with water after developing the resist.

As the developer to be used in the present invention, a developer having a solubility with respect to the EL layer forming material such as the light-emitting layer material of the above-mentioned solubility conditions.

[Photoresist Peeling Solution]

As the photoresist peeling solution to be used in the present invention, it should not dissolve the above-mentioned EL layer, but it should dissolve the photoresist layer, and the above-mentioned solvents for the photoresist can be used as they are. In a case which a positive type resist is used, the aforementioned examples of the photoresist developer used after UV exposure can also be used for peeling the photoresist layer.

Furthermore, solvents such as a strong alkaline aqueous solution, dimethylformamide, dimethylacetoamide, dimethylsulfoxide, N-methyl-2-pyrolidone; a mixture thereof; and a commercially available photoresist peeling solutions may be used. After peeling off the resist, it is rinsed with a 2-propanol or the like, and it may further be rinsed with water.

[Patterning Method]

As to the patterning operation by photolithography used in the present invention, specifically, when a positive type photoresist is used, first, after forming the EL layer on the entire surface, the photoresist layer is formed by coating on the entire surface a photoresist solution produced by dissolving the above-mentioned photoresist material in the above-mentioned photoresist solvent and drying. Then, by the pattern exposure to the photoresist layer, the photoresist in the exposed portion is developed with the resist developer as mentioned above. According to the development, the photoresist in only the unexposed portion remains. Furthermore, by eliminating the EL layer in the portion without covering the photoresist, the EL layer is patterned.

The method for forming on the entire surface the EL layer such as the light-emitting layer and the buffer layer as mentioned above is same as the ordinary EL layer formation and thus it is not particularly limited. In addition to the deposition method, the electrodeposition method, coating methods using a molten liquid of the material, a solution or a liquid mixture such as a spin coating method, a casting method, a dipping method, a bar coating method, a blade coating method, a roll coating method, a gravure coating method, a flexo printing method, and a spray coating method, or the like can be presented.

When a buffer layer is formed, it is preferable that the light-emitting layer coating solvent prevents mixing or dissolving of the buffer layer and the light-emitting layer material at the time of forming the film of the light-emitting layer so as not to dissolve the buffer layer. From this viewpoint, a light-emitting layer coating solvent having the solubility to the buffer layer material of the above-mentioned solubility conditions can be used.

Moreover, when two or more kinds of the light-emitting layers are formed parallel, it is preferable that the light-emitting layer coating solvent prevents mixing or dissolving of the photoresist layer and the light-emitting layer material at the time of forming the film of the light-emitting layer of the second color and thereafter, and furthermore, it does not dissolve the photoresist for protecting the light-emitting layer patterned already.

From this viewpoint, a light-emitting layer coating solvent having the solubility to the photoresist of the above-mentioned solubility conditions can be used. For example, when the buffer layer is dissolved in a polar solvent of water based, DMF, DMSO, alcohol or the like, and the photoresist is a common novolak based positive resist, aromatic based solvents such as isomers of benzene, toluene and xylene, and a mixture thereof, isomers of mesitylene, tetralin, p-cymene, cumene, ethylbenzene, diethyl benzene, butylbenzene, chlorobenzene, and dichlorobenzene, and a mixture thereof, ether based solvents such as anisole, a phenetole, butyl phenyl ether, tetrahydrofuran, 2-butanone, 1,4-dioxane, diethyl ether, diisopropyl ether, diphenyl ether, dibenzyl ether, and diglyme, chloro based solvents such as a dichloromethane, 1,1-dichloroethane, 1,2-dichloroethane, trichloroethylene, tetrachloroethylene, chloroform, carbon tetrachloride, and 1-chloro naphthalene, a cyclohexanone, or the like can be presented. A solvent other than them can also be used as long as it satisfies the conditions, and a solvent mixture of two or more kinds can be used as well.

Moreover, as the buffer layer coating solvent in the case of forming the buffer layer using a solvent by the coating method, a solvent having the buffer material dispersed or dissolved can be used, and it is not particularly limited. When film formation of the buffer layer is needed by a plurality of times in full color patterning or the like, it is necessary to use a buffer layer solvent not to dissolve the photoresist material, and it is further preferable to use a buffer layer solvent not to dissolve the light-emitting layer. As the buffer layer solvent to be used in the present invention, it is preferable to select a solvent having a solubility with respect to the resist material of the above-mentioned sclubility conditions. Moreover, as the buffer layer solvent, it is further preferable to select a solvent having a solubility with respect to the light-emitting material of the above-mentioned solubility conditions. For example, water, alcohols such as methanol and ethanol, and solvents such as dimethylformamide, dimethylacetamide, dimethylsulfoxide, and an N-methyl-2-pyrrolidone can be presented. Other solvents capable of satisfying the conditions can be used as well. Moreover, a mixture of two or more kinds of solvents can be used as well.

As to the method for removing the EL layer in the portion that is not covered with the photoresist in photolithography, a wet-type method of using a solvent for dissolving the EL layer and a dry etching process (dry-type method) can be used. It is preferable to use the dry etching process characterized in the anisotropy.

Therefore, it is preferable that the step of forming the predetermined pattern by photolithography is carried out by coating the EL layer to be formed into the predetermined pattern with a photoresist, exposing and developing the same to form the photoresist into the predetermined pattern, and thereafter subjecting the EL layer to dry etching process to remove the same from a portion where the photoresist is removed. Since edge portions of the etched areas can be made sharper by removing the EL layer from a portion where the photoresist is removed using the dry etching process, the width of the film thickness uneven area present at the edge portions of the etched areas can be made narrower, and as a result, a highly precise patterning can be enabled.

In the present invention, among the dry etching process, a reactive ion etching process is preferable. By using the reactive ion etching, the organic materials are chemically reacted and are decomposed to compounds having small molecular weight, the compounds can be removed from the substrate as a result of vaporization and evaporation, whereby processing by highly precise etching can be carried out in a short time.

Moreover, it is preferable to use oxygen alone or a gas containing oxygen for the dry etching process. Use of oxygen alone or a gas containing oxygen enables resolving removal by the oxidation of the organic light-emitting layer. As a result, unnecessary organic substances can be removed from the substrate, whereby processing by highly precise etching can be carried out in a short time. Further, under this condition, oxygen alone or a gas containing oxygen does not etch the transparent conductive film of oxides such as ITO, which is generally used. That is effective in that a surface of the electrode can be cleaned without damaging the electrode characteristics.

Furthermore, it is preferable to use the atmospheric pressure plasma for the above-mentioned etching process. By using the atmospheric pressure plasma, the dry etching, which generally requires a vacuum facility, can be carried out under the atmospheric pressure, whereby the time and cost required for the treatment can be reduced. In this case, etching can be performed by utilizing oxidizing resolving of organic substances by plasmatic oxygen in the atmosphere. The gas composition of the reaction atmosphere may be adjusted, as desired, by substitution and circulation of the gas.

On the other hand, as the method for removing a part of the EL layer by the wet-type method, a method of removing the EL layer using a solvent capable of dissolving or peeling off the EL layer, a method of removing the EL layer using the solvent in an ultrasonic bath, or the like can be presented.

The solvent used at this time should dissolve or peel off the light-emitting layer without peeling off the photoresist, and thus in addition to the coating solvent for the light-emitting layer, a solvent capable of satisfying the above-mentioned conditions can be selected.

Furthermore, when an ultrasonic bath is used, highly precise patterning free from inconvenience such as erosion of each pattern or dissolution of the EL layer forming material or the like at the time of patterning the EL layer using the photoresist, and it enables highly precise patterning in a relatively short period, and thus it is preferable. Also at the time of developing the above-mentioned photoresist, the ultrasonic bath may be used as well.

In the present invention, the conditions of the ultrasonic used in the ultrasonic bath are preferably execution at 20 to 100 kilohertz oscillation frequency for 0.1 to 60 seconds at 25° C. By setting such conditions, highly precise patterning is possible in a relatively short time.

[Protection Layer]

In particular, in the case of producing a full color EL device by patterning the above-mentioned light-emitting layer of three kinds of light-emitting layers by three times of photolithography, it is preferable to provide a process of forming a protection layer so as not to expose the first and second EL layers and the edge porsions thereof. When a protection layer is formed for covering the first and second EL layers and the edge porsions thereof, problems of the color mixture, pixel narrowing generation, or the like due to elution of the first and second EL layers into the second or third EL layer can be prevented in the process of forming the second EL layer and the process of forming the third EL layer. Thereby, an EL device having a plurality of kinds of highly precise light-emitting portions can be produced.

The protection layer forming process in the present invention comprises a process of coating a protection layer forming coating solution so as to cover the EL layer formed by the above-mentioned process, and a protection layer patterning process to be described later. Thereby, it is formed so as to cover the EL layer and the edge porsion thereof.

The material used as the protection layer forming coating solution is not particularly limited as long as it is a material capable of patterning in the protection layer patterning process to be described later. From the viewpoint of facilitating the patterning operation and capability of being peeled off by the resist peeling solution to be used at the time of finally removing the photoresist layer and the protection layers, it is preferable to use the photoresist mentioned above, or the like.

As to the protection layer coating method, or the like in this process, it can be carried out by the same method for the EL layer mentioned above. Moreover, this process may be carried out after peeling off the photoresist layer remaining on the EL layer by a photoresist peeling solution, or the like. Thereby, a further preferable protection layer can be formed.

Next, the protection layer patterning process in the present invention is a process for exposing the above-mentioned protection layer so as not to expose the above-mentioned EL layer and the edge porsion thereof, and developing the same. As to the exposure and development in patterning of the protection layer, the patterning operation is carried out so as to cover the EL layer by a width wider than the above-mentioned EL layer. That is, while covering the edge porsion of the EL layer, the protection layer is exposed and developed by a size to the extent not to cover the position for forming the adjacent EL layers. Thereby, the above-mentioned EL layer and the edge porsion can be protected by the protection layer. Therefore, at the time of forming the EL layer to be carried out subsequently, the first or second EL layer does not come in contact with the second or third EL layer so as to prevent the elution, and thus the problems such as the color mixture and the pixel narrowing generation can be prevented.

The exposing and developing methods or the like in the protection layer patterning process can be carried out by the same methods as in the process of patterning the photoresist layer for the EL layer as mentioned above.

Hereinafter, an example of a process for patterning the light-emitting layer three times by photolithography in the case of producing a full color EL device, including a process of forming a protection layer will be presented. In the description below, the “light-emitting layer” denotes a layer formed by coating a light-emitting layer forming coating solution and drying, and the “light-emitting portion” denotes the light-emitting layer formed at a predetermined position.

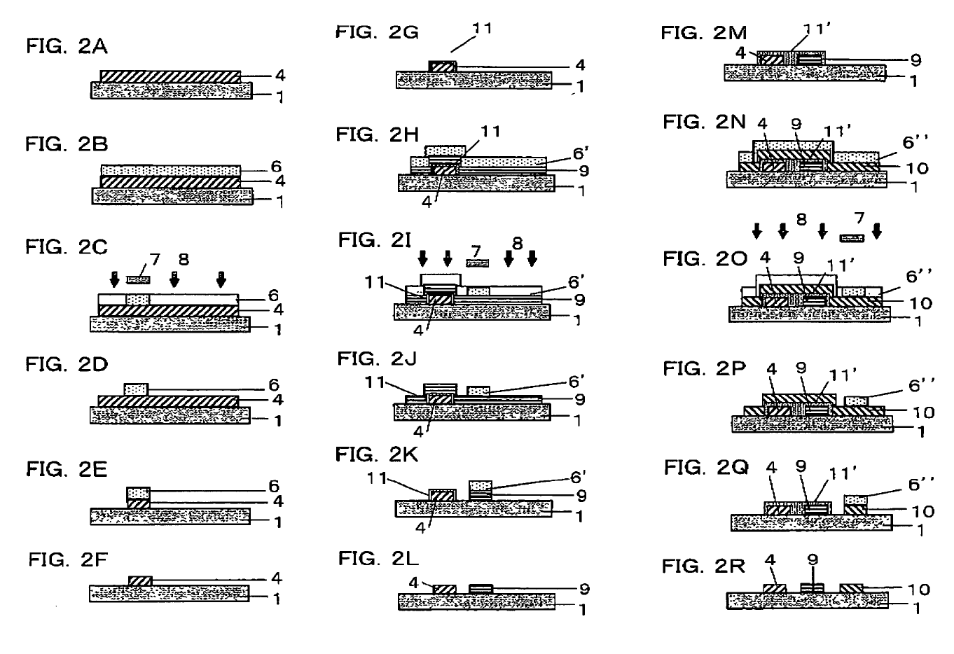

First, as shown in FIG. 2A, a light-emitting layer 4 is coated on a substrate 1 having an electrode. As shown in FIG. 2B, a photoresist layer 6 is laminated thereon. Then, as shown in FIG. 2C, with only a portion for forming a first light-emitting portion masked by a photomask 7, the remaining portions are exposed to an ultraviolet ray 8.

By developing the same with a photoresist developer and washing, as shown in FIG. 2D, the photoresist layer in the exposed portion is removed. As shown in FIG. 2E, by further removing portions of the light-emitting layer, which is bared as a result of removal of the photoresist layer by etching, and then as shown in FIG. 2F, peeling off the photoresist layer in the first light-emitting portion, the first light-emitting portion 4 is obtained.

Next, by coating a protection layer forming coating solution so as to cover the first light-emitting portion 4, a protection layer 11 is formed. Furthermore, by exposing and developing the protection layer 11, the protection layer 11 for covering the first light-emitting portion 4 and the edge porsion thereof is formed (FIG. 2G).

Then, in the same manner as mentioned above, by coating a second light-emitting layer forming coating solution, a second light-emitting layer 9 is formed. Furthermore, by coating a positive type photoresist on the entire surface thereon, a photoresist layer for a second light-emitting layer 6′ is formed (FIG. 2H).

Then, as shown in FIG. 2I, in the same manner as mentioned above, with only a portion for forming a second light-emitting portion masked by a photomask 7, the position of the portion other than the portion for forming the second light-emitting portion is exposed to an ultraviolet ray 8. The photoresist layer for the second light-emitting portion 6′ is developed with a photoresist developer and washed. Thereby, the photoresist layer for the second light-emitting layer 6′ remains in only the portion to form the second light-emitting portion (FIG. 2J).

Furthermore, by removing the second light-emitting layer 9, which is bared as a result of removal of the photoresist layer for the second light-emitting layer 6′, the second light-emitting portion 9 covered with the photoresist layer for the second light-emitting layer 6′ and the first light-emitting portion 4 covered with the first protection layer 11 remain on the substrate 1 (FIG. 2K).

Here, by peeling off the photoresist layer for the second light-emitting layer 6′ on the above-mentioned second light-emitting portion 9, the second light-emitting portion 9 is bared (FIG. 2L). Ordinarily, at this time, the first protection layer 11 formed on the first light-emitting portion 2 is peeled off simultaneously with the above-mentioned photoresist layer for the second light-emitting layer 6′.

Subsequently, as shown in FIG. 2M, a protection layer forming coating solution is applied so as to cover the first light-emitting portion 4 and the second light-emitting portion 9 bared in the above-mentioned process. Furthermore, the second protection layer 11′ is exposed and developed so as to form a second protection layer 11′ such that the first and second light-emitting portions and the edge porsions are not bared. Thereby, the second protection layer 11′ for covering the first light-emitting portion 4 and the edge porsion, and the second light-emitting portion 9 and the edge porsion is formed. The second protection layer formed on the first light-emitting portion 2 and the second protection layer formed on the second light-emitting portion may either be connected or provided individual with each other.

Then, the third color light-emitting portion is patterned. As shown in FIG. 2N, a third light-emitting layer forming coating solution is applied on the substrate 1 with the first light-emitting portion 4 covered with the second protection layer 11 formed so as to cover the first light-emitting portion 4 and the edge porsion, and the second light-emitting portion 9 covered with the second protection layer 11′ formed so as to cover the second light-emitting portion 9 and the edge porsion formed, and thus forming a third light-emitting layer 10. Furthermore, by applying a positive type photoresist thereon, a photoresist layer for the third light-emitting layer 6″ is formed. At this time, since the first light-emitting portion 4 and the edge porsion, and the second light-emitting portion 9 and the edge porsion are protected by the second protection layer 11′, the first light-emitting portion 4 and the second light-emitting portion 9 are not contacted with the third light-emitting layer 10. Thereby, elution of the first light-emitting portion 4 and the second light-emitting portion 9 from the edge porsions thereof to the third light-emitting layer 10 can be prevented.

Then, as shown in FIG. 20, with only the position for forming the third light-emitting portion masked by a photomask 7, the area other than the masked portion is exposed to the ultraviolet ray 8. By developing with the photoresist developer and washing, the photoresist layer for the third light-emitting layer 6″ disposed in the area other than the portion for forming the third light-emitting portion is removed (FIG. 2P).

Then, by removing the third light-emitting layer 10, which is bared as a result of removal of the photoresist layer for the third light-emitting layer 6″, the third light-emitting portion 10 having the photoresist layer for the third light-emitting layer 6″ on the surface remains (FIG. 2Q). In the photoresist layer for the third light-emitting layer patterning process, by the pattern exposure via a photomask disposed only in the position for forming the third light-emitting portion, a state with one layer of the second protection layer 11′ laminated on the first light-emitting portion 4 and the second light-emitting portion 9 can be provided.

Finally, as shown in FIG. 2R, by peeling off the photoresist layers and the protection layers in the uppermost layer (peeling process), the second electrode layer is formed on the bared light-emitting layers so as to produce an EL device for emitting a luminescence to the downward direction in the figure.

The EL device produced by the photolithographic process as mentioned above has the following characteristics different from those of the EL devices produced by the other production methods.

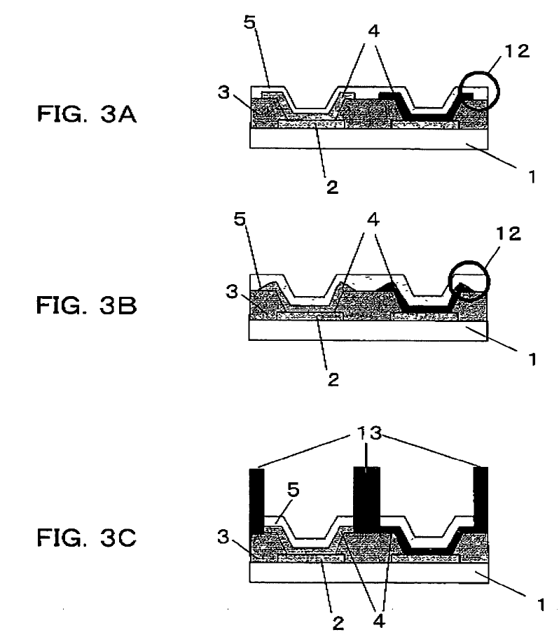

First, unlike the other production methods, since the unnecessary portion of the film once coated on the entire surface can be removed by etching according to the photolithographic process, the photolithographic process has the characteristics of the shape 12 of the edge porsion of the EL layer (see FIG. 3A). According to the common production methods such as the deposition method and the coating method, as shown in FIG. 3B, a film thickness inclination is present in the edge porsion so as to have a wide film thickness uneven area. On the other hand, according to the photolithographic process, since the patterning operation is executed by etching, as shown in FIG. 3A, film thickness of the edge porsion is same as that of the central part. That is, it provides the characteristic of having the width of the film thickness uneven area in the edge porsion of 15 μm or less, preferably 10 μm or less, and particularly preferably 7 μm or less. The “film thickness uneven area” refers to the area having the film thickness of 90% or less of the average film thickness in the flat part.

Moreover, for example, according to the ink jet method, a structure referred to as the division wall is needed (FIG. 3C) so that the EL layer can be placed within the insulating layer or the division wall. On the other hand, it is characteristic of the photolithographic process that none of the division wall, the structure for aiding the patterning operation and the surface treatment for aiding the patterning operation are required, and it is also characteristic thereof that the edge porsion of EL layer is formed on the insulating layer.

### EXAMPLES

Next, with reference to the examples, the present invention will be explained further specifically, however, the present invention is not limited to the description of the following examples.

### Example 1

(Formation of the Insulating Layer)

By washing a patterned ITO substrate of 6-inch square and 1.1 mm plate thickness, a substrate and a first electrode layer were provided. A film of a silicon dioxide (SiO2) having 2.5 or more etching selectivity to an organic compound in the dry etching process of film thickness of 2,000 angstrom was formed on the entire surface of the obtained substrate by sputtering. Furthermore, a film of a positive type photoresist (produced by Tokyo Ohka Kogyo Co., Ltd.; OFPR-800) of film thickness of 1 μm was formed on the silicon dioxide film. Thereafter, it was set on an alignment exposure machine together with an exposure mask, and only the light-emitting portion was irradiated with the ultraviolet ray. The photoresist layer in the irradiated portion was removed by developing for 20 seconds with a resist developer (produced by Tokyo Ohka Kogyo Co., Ltd.; NMD-3) and washing with water. Thereafter, portions of the silicon dioxide, which the photoresist was removed, were removed by the reactive ion etching using tetrafluoromethane as the reaction gas. By removing the photoresist with acetone, an insulating layer made of silicon dioxide was obtained.

(Film Formation for the First Buffer Layer)

0.5 ml of a buffer layer coating solution (produced by Bayer Corp; Baytron P) was taken and dropped onto the central part of the obtained substrate, and was coated to the opening part of the insulating layer by spin coating method. By maintaining at 2,500 rpm for 20 seconds, a layer was formed. As a result, the film thickness was 800 angstrom.

(Film Formation for the First Light-Emitting Layer)

As the first light-emitting layer, 1 ml of a coating solution (70 parts by weight of polyvinyl carbazol, 30 parts by weight of oxadiazol, 1 part by weight of dicyanomethylene pyran derivative, 4,900 parts by weight of monochlorobenzene) as a red color light-emitting organic material was taken and dropped onto the central part of the substrate on the buffer layer and was coated to the opening part of the insulating layer by spin coating method. By maintaining at 2,000 rpm for 10 seconds, a layer was formed. As a result, the film thickness was 800 angstrom.

2 ml of a positive type photoresist solution (produced by Tokyo Ohka Kogyo Co., Ltd.; OFPR-800) was taken and dropped onto the central part of the base member, and was coated by spin coating method. By maintaining at 500 rpm for 10 seconds, and then at 2,000 rpm for 20 seconds, a layer was formed. As a result, the film thickness was about 1 μm. Pre-baking was performed at 80° C. for 30 minutes. Thereafter, it was set on an alignment exposure machine together with an exposure mask, and the part desired to remove the light-emitting layer other than the first light-emitting portion was irradiated with the ultraviolet ray. The photoresist layer in the irradiated portion was removed by developing for 20 seconds with a resist developer (produced by Tokyo Ohka Kogyo Co., Ltd.; NMD-3) and washing with water. After post-baking at 120° C. for 30 minutes, the buffer layer and the light-emitting layer, which is bared as a result of removal of the photoresist layer, were removed by the reactive ion etching using an oxygen plasma. After totally removing the photoresist layer with acetone, again, 2 ml of a positive type photoresist solution (produced by Tokyo Ohka Kogyo Co., Ltd.; OFPR-800) was taken and dropped onto the central part of the base member, and was coated by spin coating method. By maintaining at 500 rpm for 10 seconds, and then at 2,000 rpm for 20 seconds, a layer was formed. As a result, the film thickness was about 1 μm. Pre-baking was performed at 80° C. for 30 minutes. Thereafter, it was set on an alignment exposure machine together with an exposure mask, and the photoresist layer was irradiated with the ultraviolet ray so as to have the photoresist layer remain by a width larger than the width of the first light-emitting portion each by 10 μm. The photoresist layer in the irradiated portion was removed by developing for 20 seconds with a resist developer (produced by Tokyo Ohka Kogyo Co., Ltd.; NMD-3) and washing with water. By post-baking at 120° C. for 30 minutes, the base member having the first light-emitting portion protected by the photoresist layer with a width larger than the width of the first light-emitting portion each by 10 μm was obtained.

(Film Formation for the Second Buffer Layer)

0.5 ml of a buffer layer coating solution (produced by Bayer Corp.; Baytron P) was taken and dropped onto the central part of the substrate on the obtained base member, and was coated to the opening part of the insulating layer by spin coating method. By maintaining at 2,500 rpm for 20 seconds, and then at 2,000 rpm for 20 seconds, a layer was formed. As a result, the film thickness was 800 angstrom.

(Film Formation for the Second Light-Emitting Layer)

As the second light-emitting layer, 1 ml of a coating solution (70 parts by weight of polyvinyl carbazol, 30 parts by weight of oxadiazol, 1 part by weight of coumarine 6, 4,900 parts by weight of monochlorobenzene) as a green color light-emitting organic material was taken and dropped onto the central part of the substrate on the buffer layer, and was coated to the opening part of the insulating layer by spin coating method. By maintaining at 2,000 rpm for 10 seconds, a layer was formed. As a result, the film thickness was about 800 angstrom.

2 ml of a positive type photoresist solution (produced by Tokyo Ohka Kogyo Co., Ltd.; OFPR-800) was taken and dropped onto the central part of the base member, and was coated by spin coating method. By maintaining at 500 rpm for 10 seconds, and then at 2,000 rpm for 20 seconds, a layer was formed. As a result, the film thickness was about 1 μm. Pre-baking was performed at 80° C. for 30 minutes. Thereafter, it was set on an alignment exposure machine together with an exposure mask, and the part desired to remove the light-emitting layer other than the first light-emitting portion and the second light-emitting portion was irradiated with the ultraviolet ray. The photoresist layer in the irradiated portion was removed by developing for 20 seconds with a resist developer (produced by Tokyo Ohka Kogyo Co., Ltd.; NMD-3) and washing with water. After post-baking at 120° C. for 30 minutes, the buffer layer and the light-emitting layer, which is bared as a result of removal of the photoresist layer, were removed by the reactive ion etching using an oxygen plasma. After removing the photoresist with acetone, again, 2 ml of a positive type photoresist solution (produced by Tokyo Ohka Kogyo Co., Ltd.; OFPR-800) was taken and dropped onto the central part of the base member, and was coated by spin coating method. By maintaining at 500 rpm for 10 seconds, and then at 2,000 rpm for 20 seconds, a layer was formed. As a result, the film thickness was about 1 μm. Pre-baking was performed at 80° C. for 30 minutes. Thereafter, it was set on an alignment exposure machine together with an exposure mask, and the photoresist layer was irradiated with the ultraviolet ray so as to have the photoresist layer remain by a width larger than the width of the first light-emitting portion and the second light-emitting portion each by 10 μm. The photoresist layer in the irradiated portion was removed by developing for 20 seconds with a resist developer (produced by Tokyo Ohka Kogyo Co., Ltd.; NMD-3) and washing with water. By post-baking at 120° C. for 30 minutes, the base member having the first light-emitting portion and the second light-emitting portion protected by the photoresist with a width larger than the width of the first light-emitting portion and the second light-emitting portion each by 10 μm was obtained.

(Film Formation for the Third Buffer Layer)

0.5 ml of a buffer layer coating solution (produced by Bayer Corp.; Baytron P) was taken and dropped onto the central part of the substrate on the obtained base member, and was coated to the opening part of the insulating layer by spin coating method. By maintaining at 2,500 rpm for 20 seconds, and then at 2,000 rpm for 20 seconds, a layer was formed. As a result, the film thickness was 800 angstrom.

(Film Formation for the Third Light-Emitting Layer)

As the third light-emitting layer, 1 ml of a coating solution (70 parts by weight of polyvinyl carbazol, 30 parts by weight of oxadiazol, 1 part by weight of perylene, 4,900 parts by weight of monochlorobenzene) as a blue color light-emitting organic material was taken and dropped onto the central part of the substrate on the buffer layer, and was coated to the opening part of the insulating layer by spin coating method. By maintaining at 2,000 rpm for 10 seconds, a layer was formed. As a result, the film thickness was 800 angstrom.

2 ml of a positive type photoresist solution (produced by Tokyo Ohka Kogyo Co., Ltd.; OFPR-800) was taken and dropped onto the central part of the base member, and was coated by spin coating method. By maintaining at 500 rpm for 10 seconds, and then at 2,000 rpm for 20 seconds, a layer was formed. As a result, the film thickness was about 1 μm. Pre-baking was performed at 80° C. for 30 minutes. Thereafter, it was set on an alignment exposure machine together with an exposure mask, and the part desired to remove the light-emitting layer other than the first light-emitting portion, the second light-emitting portion and the third light-emitting portion was irradiated with the ultraviolet ray. The photoresist layer in the irradiated portion was removed by developing for 20 seconds with a resist developer (produced by Tokyo Ohka Kogyo Co., Ltd.; NMD-3) and washing with water. After post-baking at 120° C. for 30 minutes, the buffer layer and the light-emitting layer, which is bared as a result of removal of the photoresist layer, were removed by the reactive ion etching using an oxygen plasma, and the base member having the first light-emitting portion, the second light-emitting portion and the third light-emitting portion protected by the photoresist was obtained. Thereafter, the photoresist was totally removed with acetone so as to expose the patterned light-emitting layer.

After drying at 100° C. for 1 hour, by depositing Ca by 500 angstrom thickness as the second electrode layer on the obtained base member, and further depositing Ag by 2, 500 angstrom thickness as the protection layer, an EL device was produced.

### Example 2

In the same manner as in the example 1 except that the insulating layer was formed as mentioned below, an organic EL device was produced.

(Formation of the Insulating Layer)

By washing a patterned ITO substrate of a 6-inch square and 1.1 mm plate thickness, a substrate and a first electrode layer were provided. 0.5 ml of an organoalkoxysilane (5% by weight isopropyl alcohol solution of TSL8113, produced by GE Toshiba Silicones) was taken, dropped onto the central part of the obtained substrate, and coated by spin coating method, and thus a film of film thickness of 2,000 angstrom was formed on the entire surface. After film formation, by heating at 200° C. for 30 minutes, a cured film of an organopolysiloxane was formed. Furthermore, a film of a positive type photoresist (produced by Tokyo Ohka Kogyo Co., Ltd.; OFPR-800) of film thickness of 1 μm was formed on the obtained substrate. Thereafter, it was set on an alignment exposure machine together with an exposure mask, and only the light-emitting portion was irradiated with the ultraviolet ray. The photoresist layer in the irradiated portion was removed by developing for 20 seconds with a resist developer (produced by Tokyo Ohka Kogyo Co., Ltd.; NMD-3) and washing with water. Thereafter, portions of the organopolysiloxane, which the photoresist was removed, were removed by the reactive ion etching using tetrafluoromethane as the reaction gas. By removing the photoresist with acetone, an insulating layer made of organopolysiloxane was obtained.

<Results>

In the examples 1 and 2, a device with a highly minute and precise pattern formed relatively easily and inexpensively was obtained.

(Evaluation for the Light-Emitting Property of the EL Device)

In the examples 1 and 2, with the ITO electrode side connected with the positive electrode and the Ag electrode side connected with the negative electrode, a direct current was applied by a source meter. Luminescence was observed from each of the first, second and third light-emitting portions respectively at the time of applying 10 V.

(Insulating Property)

In the examples 1 and 2, by the visual evaluation, the luminescence was observed only in the opening parts. Moreover, according to the measurement of the voltage-current density characteristics, the diode characteristics were shown so as to confirm the absence of the short circuit generation. By the use of dry etching at the time of patterning by photolithography, erosion to the insulating layer was prevented and the short circuit was not generated between the electrodes or between the electrodes and the wirings.

What is claimed is:

1. An electroluminescent device comprising a first electrode layer, an insulating layer, an electroluminescent layer, and a second electrode layer on a substrate, wherein at least one layer of the electroluminescent layer is formed into a predetermined pattern by photolithography comprising a dry etching process with use of a predetermined gas, and the insulating layer comprises an inorganic material having 2.5 or more etching selectivity to an organic compound in the dry etching process with use of the predetermined gas.

2. The electroluminescent device according to claim 1, wherein the predetermined gas comprises oxygen alone or a gas containing oxygen.

3. The electroluminescent device according to claim 1, wherein the inorganic material comprises an oxide of silicon and/or a nitride of silicon.

4. The electroluminescent device according to claim 1, wherein the insulating layer is disposed between the first electrode layer and the second electrode layer.

5. The electroluminescent device according to claim 1, wherein the insulating layer is disposed between a substrate wiring and the first electrode layer and/or between a substrate wiring and the second electrode layer.

6. An electroluminescent device comprising a first electrode layer, an insulating layer, an electroluminescent layer, and a second electrode layer on a substrate, wherein at least one layer of the electroluminescent layer is formed into a predetermined pattern by photolithography, and the insulating layer comprises an organopolysiloxane comprising a hydrolysis-condensation product or a hydrolysis-cocondensation product of one or more kinds of silicon compounds represented by YₙSiX₍₄₋ₙ₎,
wherein ‘Y’ denotes an alkyl group, a fluoroalkyl group, a vinyl group, an amino group, a phenyl group or an epoxy group; ‘X’ denotes an alkyl group or a halogen atom, and ‘n’ denotes an integer of from 0 to 3.

7. The electroluminescent device according to claim 6, wherein the insulating layer is disposed between the first electrode layer and the second electrode layer.

8. The electroluminescent device according to claim 6, wherein the insulating layer is disposed between a substrate wiring and the first electrode layer and/or between a substrate wiring and the second electrode layer.

9. A method for producing an electroluminescent device comprising steps of:
forming a insulating layer with use of a material containing an inorganic material having 2.5 or more etching selectivity to an organic compound in a dry etching process with use of a predetermined gas; and,
forming at least one electroluminescent layer composing an electroluminescent device into a predetermined pattern by photolithography comprising the dry etching process with use of the predetermined gas.

10. The method for producing an electroluminescent device according to claim 9, wherein the step of forming the predetermined pattern by photolithography is carried out by coating the electroluminescent layer to be formed into the predetermined pattern with a photoresist, exposing and developing the same to form the photoresist into the predetermined pattern, and thereafter subjecting the electroluminescent layer to dry etching process with use of a predetermined gas to remove the same from a portion where the photoresist is removed.

11. The method for producing an electroluminescent device according to claim 10, wherein the dry etching process is a reactive ion etching process.

12. The method for producing an electroluminescent device according to claim 10, wherein the predetermined gas comprises oxygen alone or a gas containing oxygen.

13. The method for producing an electroluminescent device according to claim 9, wherein the inorganic material comprises an oxide of silicon and/or a nitride of silicon.

14. The method for producing an electroluminescent device according to claim 9, the insulating layer is disposed between the first electrode layer and the second electrode layer.

15. The method for producing an electroluminescent device according to claim 9, wherein the insulating layer is disposed between a substrate wiring and the first electrode layer and/or between a substrate wiring and the second electrode layer.

16. A method for producing an electroluminescent device comprising steps of:
forming a insulating layer with use of a material containing an organopolysiloxane comprising a hydrolysis-condensation product or a hydrolysis-cocondensation product of one or more kinds of silicon compounds represented by YₙSiX₍₄₋ₙ₎, wherein ‘Y’ denotes an alkyl group, a fluoroalkyl group, a vinyl group, an amino group, a phenyl group or an epoxy group; ‘X’ denotes an alkyl group or a halogen atom, and ‘n’ denotes an integer of from 0 to 3; and,
forming at least one electroluminescent layer composing an electroluminescent device into a predetermined pattern by photolithography.

17. The method for producing an electroluminescent device according to claim 16, wherein the step of forming the predetermined pattern by photolithography is carried out by coating the electroluminescent layer to be formed into the predetermined pattern with a photoresist, exposing and developing the same to form the photoresist into the predetermined pattern, and thereafter subjecting the electroluminescent layer to dry etching process with use of a predetermined gas to remove the same from a portion where the photoresist is removed.

18. The method for producing an electroluminescent device according to claim 17, wherein the dry etching process is a reactive ion etching process.

19. The method for producing an electroluminescent device according to claim 17, wherein the predetermined gas comprises oxygen alone or a gas containing oxygen.

20. The method for producing an electroluminescent device according to claim 16, the insulating layer is disposed between she first electrode layer and the second electrode layer.

21. The method for producing an electroluminescent device according to claim 16 wherein the insulating layer is disposed between a substrate wiring and the first electrode layer and/or between a substrate wiring and the second electrode layer.
